(19) United States
(12) Patent Application Publication
(10) Pub. No.: US 2007/0008969 A1
(43) Pub. Date: Jan. 11, 2007

(54) Apparatuses and methods for delivering data stream content to consumer devices

(76) Inventors: Erik J. Elstermann, Carlsbad, CA (US); Kevin S. Wirick, Olivenhain, CA (US)

Correspondence Address: GENERAL INSTRUMENT CORPORATION DBA THE CONNECTED;HOME SOLUTIONS BUSINESS OF MOTOROLA, INC., 101 TOURNAMENT DRIVE, HORSHAM, PA, 19044, US

(21) Appl. No.: 11/174,939

(22) Filed: Jul. 5, 2005

(51) Int. Cl. H04L 12/56

(52) U.S. Cl. 370/390

(57) ABSTRACT

In a broadband communication network, a method (400) for delivering content to a consumer network device. The method includes: managing (402) an original data stream carrying the content, the original data stream having original recurring access units (“RAUs”) usable by the consumer network device to acquire the content; replicating (404) the original data stream to form a replicated data stream having replicated RAUs; offsetting the replicated data stream (and the replicated RAUs) relative to the original data stream by an amount of time; and arranging (408) for communication of the amount of time to the consumer network device. The amount of time is usable (410) by the consumer network device to determine a next available RAU from among at least one of the original RAUs and at least one of the replicated RAUs, and the next available RAU is usable by the consumer network device to acquire the content.

### BACKGROUND

Aspects of this invention relate generally to delivery of content carried by data streams in broadband communication networks, and more particularly to apparatuses and methods that allow accelerated acquisition and rendering of data stream content by consumer devices in broadband communication networks.

Program providers such as multiple system operators (“MSOs”) deliver content (including but not limited to pre-recorded or live electronic signals representing: images; audio; software; services such as interactive television, Internet services, telecommunication services, video-on-demand services, and the like; and other data) from a variety of public and private sources to network devices in the homes of consumers (examples of consumer network devices include personal computers/systems, hard-drive storage devices, televisions, video camera recorders, video disk recorders/players, set-top boxes, telecommunication devices, video production devices, cable modems, and local gateways, among others) via wired and wireless broadband communication networks such as cable networks, satellite networks, and telecommunication networks.

MSOs are increasingly employing packet-data-based communication technologies such as the Ethernet and Internet Protocol (“IP”) to deliver content to consumers. MSOs generally encode content using one or more well-known technologies and distribute the encoded content to consumer network devices via multicast or unicast data streams, using central reception and transmission equipment configured for two-way interaction with the consumer network devices.

Video compression is one technology that enables the efficient distribution of content to consumers, and various industry protocols relating to video compression have been promulgated. Moving Picture Experts Group (“MPEG”) protocols (MPEG-2 and MPEG-4, for example) are video compression protocols generally implemented by encoder/decoder pairs (“CODECs”) that produce/decode an encoded data stream having a particular syntax, and the encoded data stream carries content to consumer devices over channels having limited bandwidth.

According to MPEG-2 and MPEG-4, each picture of an input video is partitioned into fixed-sized frames of data that are independently decodable. Intra-coded frames (“I-frames”)—frames that are coded without referring to other pictures within the input video—recur throughout a data stream and are used by CODECs to initially acquire and render encoded content, among other things. An MPEG Group of Pictures (“GOP”) represents the number of frames between recurring I-frames in an MPEG-compressed data stream. Other types of frames in an MPEG-compressed data stream include predictive-coded frames (“P-frames”), which predict forward in a GOP, and bidirectionally interpolated frames (“B-frames”), which predict both forward and backward in a GOP.

There is a tradeoff between the number of I-frames (indeed, any unit functioning as a recurring access point in any data stream) located in an MPEG-compressed data stream (hence, the time it takes to acquire and render the content carried thereby) and the bandwidth required to convey that compressed data stream (to broadcast it to CODECs associated with consumer network devices, for example). This tradeoff in an MPEG-compressed data stream may be illustrated by roughly computing an average number of bits per picture [b_{ABE}(N)] as follows:

$${b}_{AVE} ( N ) = \frac{( ( N - 1 ) + X ) {b}_{B / P}}{N}$$

where,
N=number of pictures per GOP
X=ratio of bits per I-frame to bits per B- or P-frame
b_{B/P}=number of bits per B-picture/P-picture

A ratio [R] provides a comparison of the number of bits required for two different GOP lengths:

$$R = \frac{( ( {N}_{1} - 1 ) + X ) {N}_{2}}{( ( {N}_{2} - 1 ) + X ) {N}_{1}}$$

In one example, assuming X=3, a GOP length of N=6 requires 18% more bandwidth than a GOP length of N=15. Such additional bandwidth may be impractical or impossible to achieve in many broadband communication systems. Although protocols such as Real Time Streaming Protocol (“RTSP”) tightly synchronize client/server exchanges and may reduce the time required to acquire and/or render content, RTSP alone may not be practical for broadcast applications because of scalability issues.

There are therefore needs for bandwidth-conserving apparatuses and methods that allow accelerated acquisition and rendering of encoded content configured for broadcast distribution via packet data communication technologies to consumer devices within broadband communication networks.

### SUMMARY

In accordance with one aspect of the present invention, a method for delivering content to a consumer network device such as a decoder is operable in a broadband communication network. The method includes: managing an original data stream, such as a Moving Pictures Experts Group (“MPEG”) data stream carrying the content, the original data stream having original recurring access units, such as intra-frame-compressed pictures, associated therewith, the original recurring access units usable by the consumer network device to acquire the content from the original data stream; replicating the original data stream to form a replicated data stream having replicated recurring access units, the replicated recurring access units usable by the consumer network device to acquire the content from the replicated data stream; offsetting the replicated data stream relative to the original data stream by a predetermined amount of time, the replicated recurring access units offset by the predetermined amount of time relative to the original recurring access units; and arranging for communication of the predetermined amount of time to the consumer network device. The predetermined amount of time is usable by the consumer network device to determine a next available recurring access unit from among a group consisting of at least one of the original recurring access units and at least one of the replicated recurring access units, and the next available recurring access unit is usable by the consumer network device to acquire the content.

The method may further include the steps of: at a first time, multicasting the original data stream to a first Internet Protocol (“IP”) address; and at a second time, which is delayed relative to the first time by the predetermined amount of time, multicasting the replicated data stream to a second IP address; and based on the next available recurring access unit, when determined, authorizing the consumer network device to join a multicast group at either the first or second IP address. When the next available recurring access unit is one of the original recurring access units, the step of authorizing includes authorizing the consumer network device to join a multicast group at the first IP address to acquire the content from the original data stream, and when the next available recurring access unit is one of the replicated recurring access units, the step of authorizing includes authorizing the consumer network device to join a multicast group at the second IP address to acquire the content from the replicated data stream.

The step of arranging for communication of the predetermined amount of time to the consumer network device may include the following steps: encapsulating a message including the predetermined amount of time within a transport layer data packet; and forwarding the transport layer data packet to the consumer network device according to a network layer protocol.

In accordance with another aspect of the present invention, a computer-readable medium is encoded with a computer program which, when loaded into a processor, implements the foregoing method.

In accordance with a further aspect of the present invention, a method for receiving content is operable in a broadband communication network. The content is carried via a first data stream having a first set of recurring access units and is also carried via a second data stream having a second set of recurring access units. The second data stream is a replica of the first data stream delayed by a predetermined amount of time and the second set of recurring access units is delayed relative to the first set of recurring access units by the predetermined amount of time. The method includes: arranging for receipt of a schedule via a first multicast IP address, where the schedule includes: a first time value, the first time value representing a past time at which an initial recurring access unit of the first set of recurring access units was broadcast, a second time value, the second time value representing a future time at which a subsequent recurring access unit of the first set of recurring access units will be broadcast, and the predetermined time; based on the schedule, determining a next available recurring access unit from among a group consisting of at least one recurring access unit from the first set of recurring access units and at least one access unit from the second set of recurring access units; when the next available recurring access unit is determined to be from the first set of recurring access units, selecting the first data stream from which to receive the content; and when the next available recurring access unit is determined to be from the second set of recurring access units, selecting the second data stream from which to receive the content.

The schedule may further include a reference time, such as a network time protocol time, at which the schedule was delivered, and the first time and the second time may be expressed relative to the reference time.

The step of selecting the first data stream may include joining a multicast group at a second multicast [P address, and sending an IGMP Join Group message. Likewise, the step of selecting the second data stream may include sending an IGMP Join Group message for a third multicast IP address. The step of arranging for receipt of the schedule may include receiving a content selection indication, such as a broadcast video channel selection or a video-on-demand channel selection, from a user of a consumer network device. The step of determining the next available recurring access unit may include consulting the schedule to determine the next available recurring access unit associated with the received content selection.

According to a still further aspect of the present invention, a computer-readable medium is encoded with a computer program which, when loaded into a processor, implements the foregoing method.

According to yet another aspect of the present invention, an apparatus for handling content configured for broadcasting to a consumer network device within a broadband communication network comprises: a network interface operative to handle a plurality of data packets; a computer-readable storage medium; and a processor (associated with the broadband communication network or the consumer network device) responsive to the computer-readable storage medium and to a computer program. When loaded into the processor, the computer program is operative to: arrange for access, via the network interface, to a first data stream carrying the content, the first data stream having a first set of recurring access units, the first set of recurring access units usable by a consumer network device to acquire the content from the first data stream; arrange for access, via the network interface, to a second data stream carrying the content, the second data stream having a second set of recurring access units, the second data stream a replica of the first data stream delayed by a predetermined amount of time, the second set of recurring access units delayed relative to the first set of recurring access units by the predetermined amount of time; arrange for access to a schedule, the schedule including: a first time value, the first time value representing a past time at which an initial recurring access unit of the first set of recurring access units was broadcast, a second time value, the second time value representing a future time at which a subsequent recurring access unit of the first set of recurring access units will be broadcast, and the predetermined time, a next available recurring access unit determinable, using the schedule, from among a group consisting of at least one recurring access unit from the first set of recurring access units and at least one access unit from the second set of recurring access units; when the next available recurring access unit is determined to be from the first set of recurring access units, arrange for receipt of the content from the first data stream; and when the next available recurring access unit is determined to be from the second set of recurring access units, arrange for receipt of the content from the second data stream.

According to a yet further aspect of the present invention, a method for delivering content to a consumer network device operable in a broadband communication network. The content is carried by a data stream having recurring access units associated therewith. The method includes: receiving notification of content selection activity, the content selection activity initiated by a consumer network device; based on the content selection activity, arranging for communication with a circular buffer, the circular buffer having at least part of the data stream inserted therein, the part of the data stream in the circular buffer having at least one recurring access unit associated therewith; based on the content selection activity, arranging for determination of a next available recurring access unit within the circular buffer; and arranging for delivery of a data packet including the next available recurring access unit to the consumer network device.

The step of arranging for determination of the next available recurring access unit may include determining a memory location of the next available recurring access unit in the circular buffer, and the step of arranging for delivery of the data packet may include arranging for delivery of the data packet using an internet multimedia control protocol such as Real Time Streaming Protocol.

According to a yet still further aspect of the present invention, a computer-readable medium is encoded with a computer program which, when loaded into a processor, implements the foregoing method.

According to an additional aspect of the present invention, an apparatus for handling content configured for delivery to a consumer network device within a broadband communication network, the content carried by a data stream having recurring access units associated therewith, includes: a network interface operative to handle a plurality of data packets; a computer-readable storage medium; and a processor responsive to the computer-readable storage medium and to a computer program. When loaded into the processor, the computer program is operative to: communicate with a circular buffer to receive at least part of the data stream inserted in the circular buffer, the part of the data stream in the circular buffer having at least one recurring access unit associated therewith; receive notification, via the network interface, of content selection activity initiated by a consumer network device; based on the content selection activity, arrange for determination of a next available recurring access unit within the circular buffer; and arrange for delivery, via the network interface, of a data packet including the next available recurring access unit to the consumer network device.

### BRIEF DESCRIPTION OF THE DRAWINGS

FIG. 1 is a block diagram of a broadband communication network, in/with which various aspects of the present invention may be used.

FIG. 2 is a block diagram of a generic network device having components that are included in the various network devices shown in FIG. 1

FIG. 3 is a block diagram of an example of the consumer network device shown in FIG. 1, in/with which various aspects of the present invention may be used.

FIG. 4 is a flowchart of a method, which is operable in a broadband communication network such as the network shown in FIG. 1, for delivering content to a consumer network device in accordance with certain aspects of the present invention.

FIG. 5 is a flowchart of a method, which is operable in a broadband communication network such as the network shown in FIG. 1, for receiving content in accordance with further aspects of the present invention.

FIG. 6 is a block diagram of an alternate operational embodiment of the stream processor shown in FIG. 1.

FIG. 7 is a flowchart of a method for delivering content to a consumer network device in accordance with still further aspects of the present invention, which method is operable in a broadband communication network such as the network shown in FIG. 1 that features the operational embodiment of the stream processor shown in FIG. 6.

### DETAILED DESCRIPTION

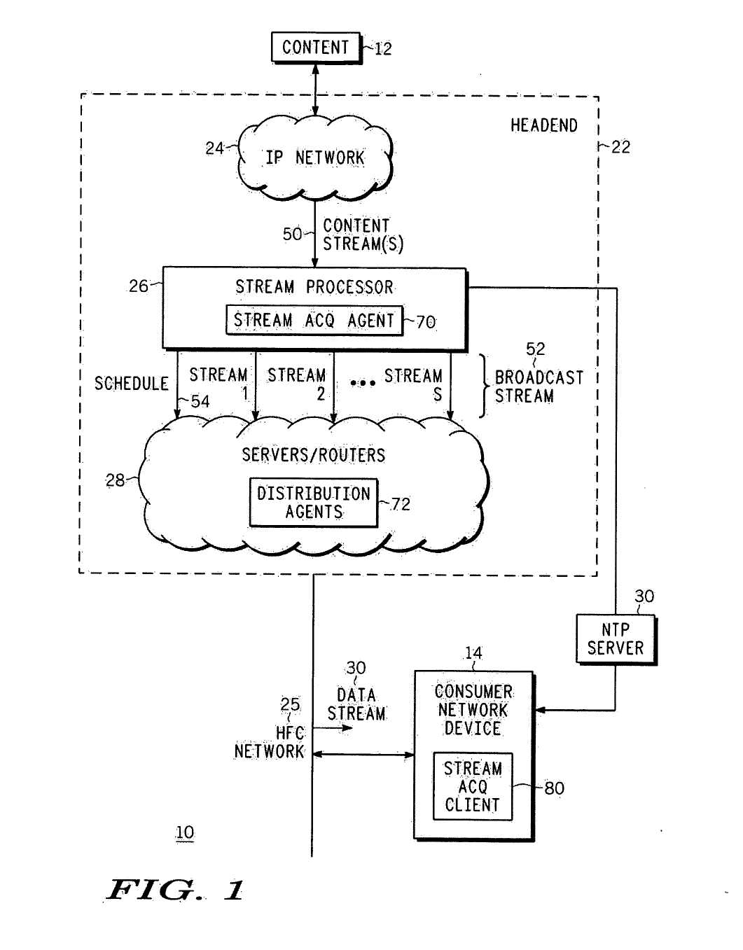

Turning now to the drawings, where like numerals designate like components, FIG. 1 is a block diagram of a broadband communication network 10, in which various aspects of the present invention maybe used. As shown, network 10 is a cable network operated by a multiple system operator (“MSO”), but it will be understood that network 10 (and connections throughout) may be any public or private, wired or wireless, transmission infrastructure or technology, including but not limited to: a fiber-optic network; a coaxial cable network; a satellite network; a cellular network; a wireless network; the Internet; a television network; a radio network; a copper wire network; or any other existing or future transmission infrastructure or technology or combination thereof, operated by any type of program provider. Content 12 (which includes, but is not limited to, pre-recorded or live electronic signals representing: images; audio; software; services such as interactive television, Internet services, telecommunication services, video-on-demand services, and the like; and other data) is carried by one or more data streams, such as data stream 30, and distributed via a network, such as hybrid fiber/coax (“HFC”) network 25, to consumer network devices, such as consumer network device 14.

As shown, consumer network device 14 is a cable or terrestrial set-top device, which has a stream acquisition client function 80 (discussed further below), although consumer network device 14 may be any wired or wireless device or combination of devices now known or later developed that is responsive to acquire and render content 12 in accordance with aspects of the present invention, including but not limited to a home- or office-based computer system, a gateway, a video receiving, recording or playback device, a stereo system, a television or monitor, a cable modem, a personal digital assistant, or a radiofrequency communication device.

In general operation of network 10, a headend 22 facilitates distribution of content 12 to consumer network device 14, and a Network Time Protocol (“NTP”) server 30 (discussed further below) is used to coordinate various activities and information between headend 22 and consumer network device 14. Headend 22 includes a number of network devices or groups thereof—an Internet Protocol (“IP”) network 24 generating one or more content streams 50 (discussed further below); a stream processor 26 (having a stream acquisition agent function 70, discussed further below) that generates broadcast streams 52 (discussed further below) and/or schedule 54 (also discussed further below) based on content stream(s) 50; and a network of servers/routers 28 (having distribution agent functions 72, also discussed further below) that receive broadcast streams 52 and/or schedule 54 for distribution to consumer network device 14 as one or more data streams 30.

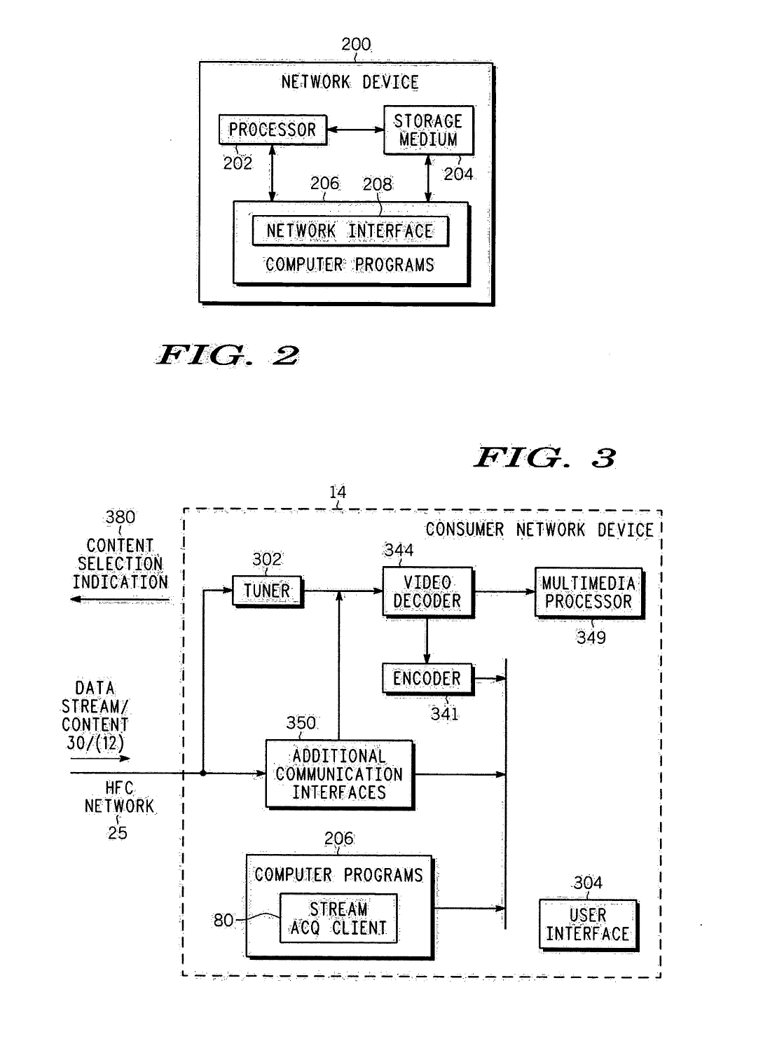

FIG. 2 is a block diagram of a generic network device 200 that has functional components generally included in, or accessible by, network devices within system 10, including elements of IP network 24, stream processor 26, servers/routers 28, NTP server 30, and consumer network device 14. A processor 202 is responsive to a computer-readable storage medium 204 and to computer programs 206. Computer-readable storage medium may be any local or remote device, now known or later developed, capable of recording or storing data, and in particular may be, or may include, a read only memory (“ROM”), a flash memory, a random access memory, a hard disk drive, all types of compact disks and digital videodisks, and/or a magnetic tape.

Computer programs 206 are generally software components implemented according to well-known software engineering practices for component-based software development and stored in computer-readable memories, such as computer-readable storage medium 204. Computer programs 206, however, may be any signal processing methods and/or stored instructions, in one or more parts, that electronically control functions set forth herein.

Network interface function 208 represents aspects of the functional arrangement of various computer programs 206 that pertain to the receipt and processing of content 12 (shown in FIG. 1), and messages relating thereto, as such content traverses paths of network devices, passing through, at each network interface, the seven vertical layers of the well-known abstract model that defines internetworking: layer 1, the Physical Layer; layer 2, the Data Link Layer; layer 3, the Network Layer; layer 4, the Transport Layer; layer 5, the Session Layer; layer 6, the Presentation Layer; and layer 7, the Application Layer. Network interface function 208 facilitates communication between functions such as stream acquisition agent 70 (shown in FIG. 1 and discussed further below) distribution agents 72 (shown in FIG. 1 and discussed further below), and/or stream acquisition client 80 (also shown in FIG. 1 and discussed further below). As such, network interface function may include data interfaces, operations support interfaces, radio frequency interfaces, and the like (implemented, for example, by routers, switches, modems, or other network connection support devices or software at each network device configured to handle communications protocols).

Referring again to FIG. 1, IP network 24 may be a regional IP network and/or IP backbone (which in practice may be included in, or separate from, headend 22 in whole or in part) using well-known components such as media gateways, signaling gateways, routers, switches, and firewalls, to produce one or more content stream(s) 50, which represent video, audio and user data for content 12 from particular media sources that has been encoded according to one or more technologies or protocols, such as a Moving Picture Experts Group (“MPEG”) protocols (for example, MPEG-2 or MPEG-4), and delivered as one or more data streams (an MPEG-2 transport stream or an MPEG-4 elementary stream delivered via RTP, for example) to stream processor 26.

Each content stream 50 includes a number of temporally spaced access points (intra-coded frames (“I-frames”) in MPEG-compressed data streams, for example), which are usable by consumer network devices to begin acquiring and rendering content carried by content stream 50. It will be appreciated that aspects of the present invention may be applied to any number of content streams 50.

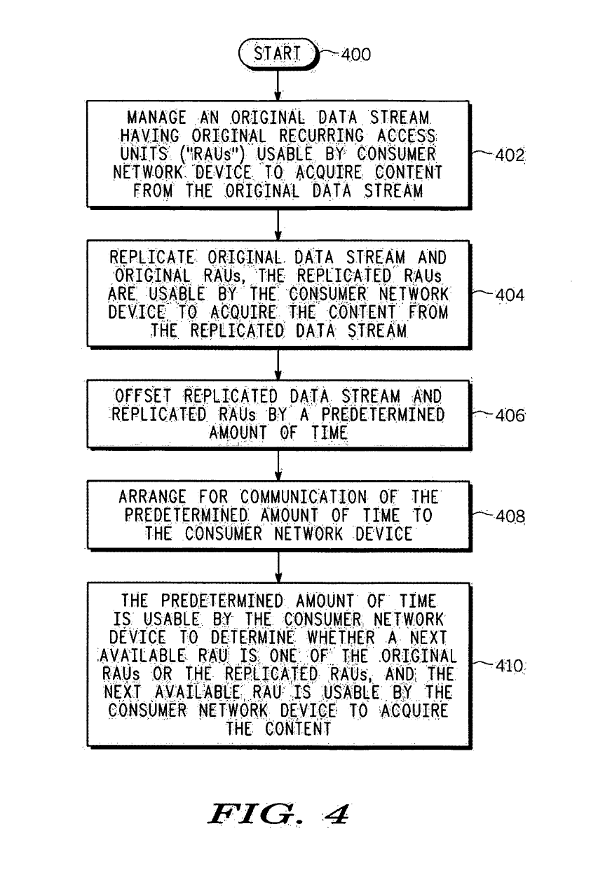

Stream processor 26, which includes or accesses the components of generic network device 200 (shown in FIG. 2), receives content stream 50 from IP network 24, and manages certain features of consumer network device 14's access to content 12 within content stream 50 in accordance with various aspects of the present invention. Stream acquisition agent function 70 (discussed further below, in connection with FIG. 4) represents aspects of the functional arrangement of various computer programs 206 (shown in FIG. 2; in one aspect, stream acquisition agent function 70 is implemented by one or more Application Layer computer programs 206) that pertain to the generation of broadcast streams 52 (stream1, stream 2, . . . stream S) and/or schedule 54, based on content stream 50, and transmission to/use by consumer network device 14. Although stream processor 26 is shown within headend 22, it will be appreciated that stream processor 26 may be located at any local or regional distribution point associated with a broadband communication network.

Servers/routers 28, which also include or access the components of generic network device 200 (shown in FIG. 2), are responsive to stream processor 26. Servers/routers 28 are responsible for making appropriate broadcast stream(s) 52 and/or schedule 54, available to consumer device 14 as one or more packet-data streams 30 via distribution agents 72 (discussed further below, in connection with FIG. 4).

FIG. 3 is a block diagram of an exemplary consumer network device 14, which includes or accesses the components of generic network device 200 (shown in FIG. 2), in/with which various aspects of the present invention may be used. Using one or more channels, protocols and/or techniques, consumer network device 14 communicates information to, and receives information from, headend 22 via HFC network 25. For example, among other things, consumer network device 14 communicates content selection indication 380, which may be a preliminary or final indicator of particular content 12 (a channel signal, for example) offered by the MSO operating broadband communication network 10 (shown in FIG. 1) that has been selected by a consumer (not shown) using any type of well-known user interface 304 such as a remote control, mouse, stylus, microphone, keyboard, or display. In response, in accordance with aspects of the present invention discussed further below, consumer network device 14 receives, among other things, one or more packet-data streams 30 that include the selected content (for example, data stream 30, which may be or include an MPEG stream).

Additional communication interfaces 350 may also facilitate consumer network device 14's one-or two-way communication with other internal or external devices or networks thereof, such as cable modems, personal computers, data terminal equipment, telephones, media players, data storage devices, personal digital assistants, or any other IP-enabled network, device or component/combination thereof, along with associated network support devices and/or software.

Internal elements associated with consumer network device 14 include a tuner 302, which includes well-known arrangements of components, operating (by tuning to a particular in-band or cut-of-band channel signal, for example) using well-known manners and techniques to receive particular information from headend 22 and/or additional communication interfaces 350.

A video decoder 344 is responsive to receive and decode signals from tuner 302. Video decoder 344 includes well-known arrangements of components, such as demodulators, responsive to receive digital signals, such as digital data packets of data stream 30, and to output video information. Video information that may require format translation or modification for compatibility with capabilities of consumer network device 14 and peripherals thereof (not shown) may be passed to encoder 341 for formatting. Encoder 341 includes well-known arrangements of components, and operates in accordance with well-known methods and techniques.

Video information from video decoder 344 and/or encoder 341 may be passed to multimedia processor 349, which is operative to perform predetermined coding techniques to arrange video information into displayable/storable formats, in accordance with well-known methods and techniques. Internal arrangements of multimedia processor 349 are well known, and may include analog-to-digital converters, general or special-purpose processors or application-specific integrated circuits such as encoder/decoder pairs (“CODECs”) (MPEG CODECs, for example), storage media and/or buffers, along with demultiplexors for demultiplexing and/or synchronizing at least two streams (for example, video and audio).

Stream acquisition client function 80 (discussed further below, in connection with FIG. 4) represents aspects of the functional arrangement of various computer programs 206 (in one aspect, stream acquisition client function 80 is implemented by one or more Application Layer computer programs) that operate to acquire and render the content selected via content selection indication 380 and carried by data stream 30. More specifically, stream acquisition client function 80 represents functions relating to the handling of schedule 54 and/or broadcast streams 52 to enable acquisition and rendering of selected broadcast streams 52 by consumer network device 14 in accordance with various aspects of the present invention.

With continuing reference to FIGS. 1-3, FIG. 4 is a flowchart of a method, which is operable in a broadband communication network, for delivering content, such as content 12, to a consumer network device, such as consumer network device 14, in accordance with certain aspects of the present invention. The method may be implemented when one or more computer programs, such as computer programs 206 associated with headend 22 (for example, stream acquisition agent 70 and/or distribution agents 72) are loaded into a processor, such as a processor associated with stream processor 26, and executed.

The method begins at block 400, and continues at block 402, where an original data stream, such as content stream 50, is managed. The original data stream has original recurring access units (“RAUs”), which are usable by the consumer network device to acquire the content from the original data stream. It will be understood that RAUs may be random access units, such as MPEG I-frames, or any other element(s) or process(es) associated with a data stream that facilitate access to such data stream by receiving devices.

Next, at block 404, the original data stream and original RAUs are replicated. The replicated RAUs are usable by the consumer network device to acquire the content from the replicated data stream. The replicated data stream is offset relative to the original data stream—and the replicated RAUs are offset relative to the original RAUs—by a predetermined amount of time at block 406.

In one implementation associated with point-to-multipoint applications, stream processor 26 creates multiple time-delayed replicas of each content stream 50 (and thus time-delayed replicas of the I-frames associated with content stream 50), which for one content stream are shown as broadcast streams 52 (see FIG. 1). Stream processor 26 determines the maximum time between consecutive I-frames in content stream 50, and based on a predetermined number (“S”) of broadcast streams 52 (which may be specified by the MSO, for example), computes the time offset (“Δt”) between broadcast streams. That is,

$$Δ t = \frac{max ( {t}_{RAU} [ i ] - {t}_{RAU} [ i - 1 ] )}{S}$$

Alternatively, stream processor 26 could compute S based on an operator-specified Δt. In either case, the objective is to make Δt small enough to facilitate fast acquisition and rendering of content 12 by consumer network device 14, while keeping S practical.

Stream processor 26 then forwards the original content stream (by way of example, “stream 1” as shown in FIG. 1 represents the original content stream) to a unique multicast destination address (“N_{1”}), which may be implemented/maintained using well-known methods and techniques by distribution agents function 72 and/or servers routers 28. N₁, for example, may be advertised in the Session Description Protocol (“SDP”) for a particular session. Next, a replica of stream 1, delayed by an amount of time Δt, is forward to a different multicast destination address (“N_{2”}), which could also be included in the SDP, or, alternatively, a relationship to N₁ could be established a priori. In general, each replica stream, “Stream k,” is delayed (k-1) Δt relative to content stream 50, and sent to multicast address Nₖ, where 1≦k≦S.

In addition, stream processor 26 creates schedule 54, which may contain, among other things: (1) certain global information, such as an NTP timestamp (eight bytes), which represents the NTP wallclock time at which schedule 54 is delivered into network 10; and (2) certain information associated with each content stream 50/service available for selection by consumer network device 14. For example, for each content stream 50 and its associated broadcast streams 52, the following information may be included in schedule 54: the time at which the current RAU for stream 1 was delivered into network 10 (which may be expressed as a two-byte two's-complement offset in milliseconds relative to the NTP timestamp); the time at which the next RAU for stream 1 will be delivered into the network (which may also be expressed as a two-byte two's complement offset in milliseconds relative to the NTP timestamp); the time offset (Δt) between streams (which may be expressed in milliseconds using one-byte); and the number of available broadcast streams 52 (which may be a one-byte value).

The foregoing discussion assumes that stream processor 26 and consumer network device 14 are synchronized to a common NTP timebase. It is also possible, however, to employ Real Time Streaming Protocol (“RTSP”) Sender Reports (or features of a similar protocol) to achieve similar functionality. Sender Reports relate an absolute time (usually, but not necessarily, NTP time) to a relative time (Real-time Transport Protocol (“RTP”) timestamps, for example) for each content stream 50, allowing a consumer network device to compute the relative offset between streams, and thus the time of the next available RAU for a particular content stream.

At block 408, it is arranged for the predetermined amount of time from block 406 to be communicated to the consumer network device. As is shown in block 410, the predetermined amount of time is usable by the consumer network device to determine whether a next available RAU is one of the original RAUs or the replicated RAUs, and the next available RAU is usable to acquire the content (content acquisition is discussed further below, in connection with FIG. 5).

With continuing reference to FIGS. 1-3, FIG. 5 is a flowchart of a method, which is operable in a broadband communication network such as network 10, for receiving content such as content 12, in accordance with certain aspects of the present invention. The content is carried via both a first data stream and a second data stream, and both data streams have RAUs offset relative to each other by a predetermined amount of time. The method may be implemented when one or more computer programs, such as computer programs 206 associated with consumer network device 14 (for example, stream acquisition client function 80) are loaded into a processor, such as a processor associated with consumer network device 14, and executed.

The method begins at block 500, and continues at block 502, where it is arranged for receipt of a schedule via a first multicast IP address. The schedule includes a first time value representing a past time at which an initial RAU associated with the first data stream was broadcast, and a second time value representing a future time at which a subsequent RAU associated with the first data stream will be broadcast, and also includes the predetermined amount of time.

In one implementation, consumer network device 14 joins the multicast group for schedule 54 using a Network Layer multicast protocol such as Internet Group Management Protocol (“IGMP”) (via issuance of an IGMP Join message for the multicast group for schedule 54, for example). The IP address of the multicast group for schedule 54 may be advertised by headend 22 (via distribution agents function 72 and/or servers/routers 28 using SAP/SDP, for example), or may be configured a priori, such as during initial consumer device 14 configuration. Consumer network device 14 remains tuned to the multicast group for schedule 54 indefinitely.

At diamond 504, based on the schedule, it is determined whether a next available RAU is associated with the first data stream or the second data stream. If the next available RAU is associated with the first data stream, then, at block 506, the first data stream is selected from which to receive the content, and if the next available RAU is associated with the second data stream, then, at block 508, the second data stream is selected from which to receive the content.

In implementation, the information in schedule 54, possibly considering specified or estimated delays, is used by consumer network device 14 to determine the next available I-frame, and a particular stream may be selected/received by issuing an IGMP Join for the multicast group associated with the stream having the next available I-frame. An IGMP Leave may be necessary to leave the preceding multicast group and free up sufficient bandwidth to receive the selected content.

To further decrease the time required to acquire and render content 12, if a consumer operates user interface 304 in a manner that indicates service selection is monotonically increasing or decreasing (that is, the consumer is “channel surfing”), consumer network device 14 could “arm” itself using information in schedule 54 for the next highest and next lowest channels, rather than waiting for the eventual content selection to be made. Similarly, if a consumer enters a channel selection by keypad, consumer network device 14 could pre-process the schedule information for the ten channels remaining before the last key press. For example, assuming the desired channel is 206, then schedule information for channels 200 through 209 could be obtained immediately after the consumer enters digits ‘2’ and ‘0’.

Thus, apparatuses and methods have been presented that minimize delays associated with a consumer network device's acquisition of different content (channel change delays, for example) in multicast environments such as broadcast video or certain video-on-demand applications. A consumer network device may compute and select a multicast stream with the nearest next access opportunity, and bandwidth penalties associated with carrying additional recurring access units such as I-frames within a data stream are avoided. Assuming six bytes per channel, a schedule message rate of two per second, and 100 content streams, the required bandwidth for the schedule stream would be approximately 10 kbps.

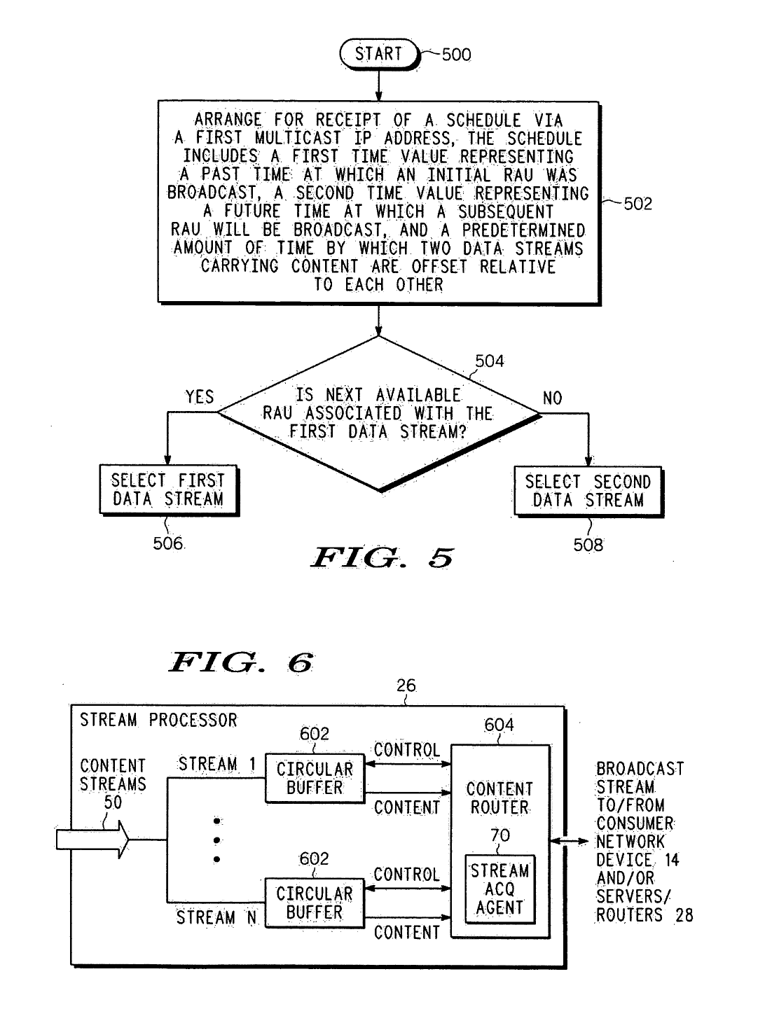

A variation using unicast point-to-point connections and two-way protocols (such as RTSP or RTSP-like protocols) is also possible. A functional block diagram of a stream processor 26 (which may also include or access elements of generic network device 200, shown in FIG. 2) in accordance with aspects of the present invention associated with this variation is shown in FIG. 6. As shown, stream processor 26 receives N content streams 50, and each is sent to its own circular buffer 602. Circular buffers 602 may be implemented using well-known structures, methods and techniques.

A content router 604, which includes or has access to stream acquisition agent function 70, is responsible for retrieving content from any of these buffers and sending it as broadcast stream 52 to a specific consumer network device, such as consumer network device 14.

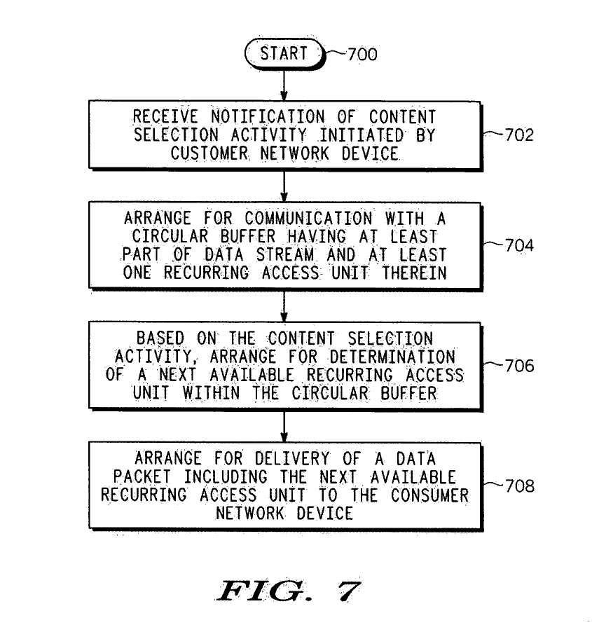

With continuing reference to FIGS. 1-3 and FIG. 6, FIG. 7 is a flowchart of a method, which is operable in a broadband communication system, for delivering content to a consumer network device, such as consumer network device 14. The content is carried by a data stream having recurring access points such as I-frames. The method begins at block 700, and continues at block 702, where notification of content selection activity initiated by a consumer network device is received.

In one possible implementation, stream processor 26 shown in FIG. 6 is responsible (via stream acquisition client function 80) for communication with consumer network device 14 (using RTSP, for example) to determine the particular content stream 50 desired by the consumer network device that should be sent (for example, unicast) as broadcast stream 52—content selection indications 380 (shown in FIG. 3) made by the consumer propagate back to stream processor 26, and are received by stream acquisition agent function 70.

At block 704, communication with a circular buffer is arranged based on the content selection activity. The circular buffer has at least part of the data stream inserted therein, with at least one RAU. Next, at block 706, determination of a next available RAU within the circular buffer is arranged, and at block 708, it is arranged for delivery of a data packet including the next available RAU to the consumer network device.

In implementation, stream acquisition agent function 70 may be responsible for communication with content router 604 (via a media server/client interface, for example), instructing content router 604 to cease streaming content from one circular buffer 602, and to begin streaming content from the desired circular buffer 602. Content router 604 communicates with each circular buffer 602 to determine the memory location of the most recent RAU for each stream. Circular buffers 602 need only be large enough to retain the maximum number of bytes expected between consecutive RAUs. Content router 604 is responsible for switching streams distributed to consumer network device 14, and unicasting the content therefrom to individual consumer network devices, ensuring that the first data packet delivered to consumer network device 14 after a content change request includes a RAU.

Thus, at the expense of some increased complexity, the foregoing approach would facilitate the near immediate delivery of an access point to a consumer network device when a content selection request is received if the number of consumer network devices is limited to a practical number, and would make content selection mostly transparent to the underlying network (for example, the need for transmission of an additional schedule, such as schedule 54, to a consumer network device is obviated).

Aspects of the present invention described herein address the needs for bandwidth-conserving methods and apparatuses that allow accelerated acquisition and rendering of encoded content configured for broadcast distribution via packet data communication technologies to consumer devices within broadband communication networks. One or more processors packaged together or with other elements of central or regional network elements or consumer network devices may implement functions described herein in a variety of ways. It will be appreciated, however, that aspects of the present invention are not limited to any specific embodiments of computer software or signal processing methods—functions described herein are processes that convey or transform data in a predictable way, and may generally be implemented in hardware, software, firmware, or any combination thereof.

Moreover, although certain functions herein have been referred to as “agents” and “clients”, such functions need not be implemented using traditional client-server architectures in which computer application programs are configured to cause clients, such as consumer devices, to request services from server-based service providers in a network such as the Internet, but may be implemented in any suitable manner.

When one element is indicated as being responsive to another element, the elements may be directly or indirectly coupled. Connections depicted herein may be logical or physical in practice to achieve a coupling or communicative interface between elements. Connections may be implemented as inter-process communications among software processes.

It will furthermore be apparent that other and further forms of the invention, and embodiments other than the specific embodiments described above, may be devised without departing from the spirit and scope of the appended claims, and it is therefore intended that the scope of this invention will be governed by the following claims.

1. In a broadband communication network, a method for delivering content to a consumer network device, the method comprising:
managing an original data stream carrying the content, the original data stream having original recurring access units associated therewith, the original recurring access units usable by the consumer network device to acquire the content from the original data stream;
replicating the original data stream to form a replicated data stream having replicated recurring access units, the replicated recurring access units usable by the consumer network device to acquire the content from the replicated data stream;
offsetting the replicated data stream relative to the original data stream by a predetermined amount of time, the replicated recurring access units offset by the predetermined amount of time relative to the original recurring access units; and
arranging for communication of the predetermined amount of time to the consumer network device,
the predetermined amount of time usable by the consumer network device to determine a next available recurring access unit from among a group consisting of at least one of the original recurring access units and at least one of the replicated recurring access units, the next available recurring access unit usable by the consumer network device to acquire the content.

2. The method according to claim 1, further comprising:
at a first time, multicasting the original data stream to a first Internet Protocol (“IP”) address; and
at a second time, the second time delayed relative to the first time by the predetermined amount of time, multicasting the replicated data stream to a second IP address.

3. The method according to claim 2, further comprising:
based on the next available recurring access unit, when determined, authorizing the consumer network device to join a multicast group at one of the first and second IP addresses.

4. The method according to claim 3, wherein the step of authorizing comprises:
when the next available recurring access unit comprises one of the original recurring access units, authorizing the consumer network device to join a multicast group at the first IP address to acquire the content from the original data stream; and
when the next available recurring access unit comprises one of the replicated recurring access units, authorizing the consumer network device to join a multicast group at the second IP address to acquire the content from the replicated data stream.

5. The method according to claim 4, wherein the step of arranging for communication of the predetermined amount of time to the consumer network device comprises:
encapsulating a message including the predetermined amount of time within a transport layer data packet; and
forwarding the transport layer data packet to the consumer network device according to a network layer protocol.

6. The method according to claim 5, wherein the network layer protocol comprises an Internet Protocol “IP” protocol.

7. The method according to claim 6, wherein the transport layer data packet comprises an Internet Group Management Protocol (“IGMP”) packet.

8. The method according to claim 5, wherein the consumer network device comprises a decoder.

9. The method according to claim 8, wherein the original data stream comprises a Moving Pictures Experts Group (“MPEG”) data stream.

10. The method according to claim 9, wherein the original and replicated recurring access units comprise intra-frame-compressed pictures.

11. A computer-readable medium encoded with a computer program which, when loaded into a processor, implements the method of claim 1.

12. In a broadband communication network, a method for receiving content, the content carried via a first data stream having a first set of recurring access units and carried via a second data stream having a second set of recurring access units, the second data stream a replica of the first data stream delayed by a predetermined amount of time, the second set of recurring access units delayed relative to the first set of recurring access units by the predetermined amount of time, the method comprising:
arranging for receipt of a schedule via a first multicast IP address, the schedule comprising
a first time value, the first time value representing a past time at which an initial recurring access unit of the first set of recurring access units was broadcast,
a second time value, the second time value representing a future time at which a subsequent recurring access unit of the first set of recurring access units will be broadcast, and
the predetermined time;
based on the schedule, determining a next available recurring access unit from among a group consisting of at least one recurring access unit from the first set of recurring access units and at least one access unit from the second set of recurring access units;
when the next available recurring access unit is determined to be from the first set of recurring access units, selecting the first data stream from which to receive the content; and
when the next available recurring access unit is determined to be from the second set of recurring access units, selecting the second data stream from which to receive the content.

13. The method according to claim 12, wherein the schedule further comprises a reference time at which the schedule was delivered, and wherein the first time and the second time are expressed relative to the reference time.

14. The method according to claim 13, wherein the reference time comprises a network time protocol (“NTP”) time.

15. The method according to claim 12, wherein the step of selecting the first data stream comprises joining a multicast group at a second multicast IP address.

16. The method according to claim 15, wherein the step of selecting the first data stream further comprises sending an IGMP Join Group message for the second multicast IP address.

17. The method according to claim 15, wherein the step of selecting the second data stream comprises joining a multicast group at a third multicast IP address.

18. The method according to claim 17, wherein the step of selecting the second data stream further comprises sending an IGMP Join Group message for the third multicast IP address.

19. The method according to claim 12, wherein the step of arranging for receipt of the schedule comprises: receiving a content selection indication from a user of a consumer network device.

20. The method according to claim 19, wherein the content selection indication comprises one of a broadcast video channel selection and a video-on-demand channel selection.

21. The method according to claim 19, wherein the step of determining the next available recurring access unit comprises: consulting the schedule to determine the next available recurring access unit associated with the received content selection.

22. A computer-readable medium encoded with a computer program which, when loaded into a processor, implements the method of claim 12.

23. An apparatus for handling content configured for broadcasting to a consumer network device within a broadband communication network, the apparatus comprising:
a network interface operative to handle a plurality of data packets;
a computer-readable storage medium; and
a processor responsive to the computer-readable storage medium and to a computer program, the computer program, when loaded into the processor, operative to:
arrange for access, via the network interface, to a first data stream carrying the content, the first data stream having a first set of recurring access units, the first set of recurring access units usable by a consumer network device to acquire the content from the first data stream;
arrange for access, via the network interface, to a second data stream carrying the content, the second data stream having a second set of recurring access units, the second data stream a replica of the first data stream delayed by a predetermined amount of time, the second set of recurring access units delayed relative to the first set of recurring access units by the predetermined amount of time;
arrange for access to a schedule, the schedule comprising
a first time value, the first time value representing a past time at which an initial recurring access unit of the first set of recurring access units was broadcast,
a second time value, the second time value representing a future time at which a subsequent recurring access unit of the first set of recurring access units will be broadcast, and
the predetermined time, a next available recurring access unit determinable, using the schedule, from among a group consisting of at least one recurring access unit from the first set of recurring access units and at least one access unit from the second set of recurring access units;
when the next available recurring access unit is determined to be from the first set of recurring access units, arrange for receipt of the content from the first data stream; and
when the next available recurring access unit is determined to be from the second set of recurring access units, arrange for receipt of the content from the second data stream.

24. The apparatus according to claim 23, wherein the processor is associated with a central network device within the broadband communication network.

25. The apparatus according to claim 23, wherein the processor is associated with the consumer network device.

26. In a broadband communication network, a method for delivering content to a consumer network device, the content carried by a data stream having recurring access units associated therewith, the method comprising:
receiving notification of content selection activity, the content selection activity initiated by a consumer network device;
based on the content selection activity, arranging for communication with a circular buffer, the circular buffer having at least part of the data stream inserted therein, the part of the data stream in the circular buffer having at least one recurring access unit associated therewith;
based on the content selection activity, arranging for determination of a next available recurring access unit within the circular buffer; and
arranging for delivery of a data packet including the next available recurring access unit to the consumer network device.

27. The method according to claim 26, wherein the step of arranging for determination of the next available recurring access unit comprises:
determining a memory location of the next available recurring access unit in the circular buffer.

28. The method according to claim 27, wherein the step of arranging for delivery of the data packet comprises:
arranging for delivery of the data packet using an internet multimedia control protocol.

29. The method according to claim 28, wherein the Internet multimedia control protocol comprises Real Time Streaming Protocol (“RTSP”).

30. A computer-readable medium encoded with a computer program which, when loaded into a processor, implements the method of claim 26.

31. An apparatus for handling content configured for delivery to a consumer network device within a broadband communication network, the content carried by a data stream having recurring access units associated therewith, the apparatus comprising:
a network interface operative to handle a plurality of data packets;
a computer-readable storage medium; and
a processor responsive to the computer-readable storage medium and to a computer program, the computer program, when loaded into the processor, operative to:
communicate with a circular buffer to receive at least part of the data stream inserted in the circular buffer, the part of the data stream in the circular buffer having at least one recurring access unit associated therewith;
receive notification, via the network interface, of content selection activity initiated by a consumer network device;
based on the content selection activity, arrange for determination of a next available recurring access unit within the circular buffer; and
arrange for delivery, via the network interface, of a data packet including the next available recurring access unit to the consumer network device.
